(19) United States
(12) Patent Application Publication
(10) Pub. No.: US 2026/0226578 A1
(43) Pub. Date: Aug. 6, 2026

(54) LASER PATTERNING ASSISTED PROCESSING ENABLING MAGNETIC DOMAIN ENGINEERING OF SOFT MAGNETIC ALLOYS

(71) Applicant: UNIVERSITY OF PITTSBURGH-OF THE COMMONWEALTH SYSTEM OF HIGHER EDUCATION, PITTSBURGH, PA (US)

(72) Inventors: Ahmed Talaat, Pittsburgh, PA (US); Paul R. Ohodnicki, Allison Park, PA (US); Tyler William Paplham, Getzville, NY (US)

(73) Assignee: UNIVERSITY OF PITTSBURGH-OF THE COMMONWEALTH SYSTEM OF HIGHER EDUCATION, PITTSBURGH, PA (US)

(21) Appl. No.: 19/142,834

(22) PCT Filed: Dec. 28, 2023
(86) PCT No.: PCT/US2023/086282

§ 371 Date: Jun. 24, 2025

Related U.S. Application Data
(60) Provisional application No. 63/435,639, filed on Dec. 28, 2022.

(51) Int. Cl. C21D 10/00; C22C 38/00; C22C 38/02; C22C 38/12; C22C 38/16; C22C 45/02; H01F 1/38

(52) U.S. Cl. CPC C21D 10/00; C22C 38/002; C22C 38/02; C22C 38/12; C22C 38/16; C22C 45/02; H01F 1/38; C21D 2201/03; C22C 2200/02; C22C 2200/04; C22C 2202/02

(57) ABSTRACT

Disclosed herein are alloys comprising spatially optimized domain structures and microstructures of alloys. Also disclosed herein are methods for domain engineering, particularly in magnetic material, using either pulsed or continuous wave laser irradiation. Methods disclosed herein can be used to vary magnetic properties in a magnetic material, including but not limited to magnetic domain structure, hysteresis, and eddy currents.

### CROSS-REFERENCE TO RELATED APPLICATIONS

This application claims priority under 35 U.S.C. § 119 (e) to U.S. Provisional Patent Application No. 63/435,639, filed Dec. 28, 2022, which is hereby incorporated by reference in its entirety.

### FIELD OF THE INVENTION

Disclosed herein are alloys comprising spatially optimized domain structures and microstructures, and related methods of manufacture.

Embodiments described herein relate generally to methods for preparing magnetic material, in particular magnetic material with spatially optimized domains.

### BACKGROUND OF THE INVENTION

Crystallization from an amorphous precursor has been historically exploited to synthesize metastable soft magnetic nanocomposite systems comprised of transition metal rich ferromagnetic nanocrystals embedded within an intergranular amorphous phase. In this class of alloys, rapid solidification processing with cooling rates of ~10⁶ K/s for carefully selected complex alloy chemistries enables the synthesis of an amorphous precursor (1, 2, 3).

Subsequent thermal processing steps produce highly refined microstructure with nanometer-scale grain sizes to enable effective exchange averaging and highly reversible magnetization processes as described by the random anisotropy model (4). FeSiNbBCu-based alloys such as FINEMET®, originally invented by Yoshizawa et al. (5) represent the first class of commercial alloys. Superior soft magnetic properties in this alloy system results from ubiquitous nucleation and self-limiting growth of nanocrystals due to expulsion of glass formers to the intergranular amorphous matrix, requiring significant metalloids and early transition metals to reduce effective saturation magnetization.

The tradeoff of magnetic property optimization is generally realized by means of thermal processing, which plays a major role in determining nucleation and growth under selected annealing temperatures and selected alloy chemistries.

Recent work demonstrates the balance between nucleation and growth can alternatively be optimized through highly controlled thermal processing of amorphous precursors with extremely rapid heating and subsequent cooling rates on order of 10²-10³ K/s referred to as “flash annealing”, with a high density of nucleation sites achieved for limited nanocrystal growth even for alloy chemistries which do not produce nanometer-scale microstructures with conventional annealing (6,7). Unprecedented combinations of high saturation magnetization and low losses are realized through flash annealing of alloy chemistries with substantially reduced metalloid and early transition metal element glass formers and diffusion inhibitors. High heating and cooling rates generated during laser radiation offered great advantages for rapid thermal processing of various families of magnetic materials (8) and surface treatment of ferromagnetic amorphous ribbons (9,10).

Continuous-wave laser processing with heating and cooling rates on the order of 105 K/s has been reported to achieve site-specific surface crystallization of amorphous and nanocrystalline soft magnetic alloys (10).

Laser-patterning and devitrification provide a novel method for realizing emergent properties in modified regions at the ribbon surface consisting of periodic localized laser spots thermally treated under rapid heating and cooling conditions due to the detailed thermal diffusion effects associated with laser annealing. As such, unique microstructures and also magnetic domain structures can be developed, with spatial variations that are not otherwise achievable by traditional annealing methods.

Reel-to-reel strain annealing methods, also referred to as in-line methods, have been recently employed, showing great promise for precise control of magnetic properties with additional benefits for scalability (11,12). Although flash annealing methods have demonstrated significant material property performance improvements at laboratory scale, there are inherent technical challenges for scaling to a manufacturing environment.

### SUMMARY OF THE INVENTION

Provided herein is a method for modifying the magnetic domain structure of an initially amorphous material through the method comprising the step of exposing the material to laser irradiation. In an example embodiment, pulsed laser processing entails heating and cooling rates on the order of 108-109K/s, which will allow for a unique combination of surface amorphization upon melting and re-solidification process, with the potential for optimizing the periodicity such that the bulk of the ribbon has a fine-grained nanocrystalline microstructure upon diffusion of heat from the laser irradiated surface region, both radially outwards and through the thickness of the ribbon. In certain other embodiments, the method uses continuous wave laser processing.

The methods disclosed herein can provide an unprecedented level of spatial control, resulting in spatially optimized magnetic domain structures as well as spatially optimized microstructures to achieve spatially varied phase transformations. Combined domain structure engineering through a scalable manufacturing process can ultimately allow for optimized soft magnetic properties specifically relevant for magnetic components in power electronics and electric vehicles applications.

The methods disclosed herein can also result in reduced hysteresis and/or eddy current losses upon the optimization of magnetization processes and domain wall pinning by means of laser scribing, through optimization of the magnetic domain structure and even producing local amorphous structures for otherwise crystalline materials due to the extremely fast heating and cooling rates. The amorphization of initially crystalline materials is a novel and unique approach to domain structure and magnetic property optimization.

### BRIEF DESCRIPTION OF THE DRAWINGS

FIG. 1 shows the variation of temperature with time at a laser-irradiated spot at depths of (a) 0.5 μm and (b) 7.5 μm below the surface, and (c) 15 μm on the back ribbon surface. Horizontal axis: time (sec); vertical axis: temperature (K).

FIG. 2 shows FEA simulations of areas that have surpassed temperatures for which crystallization (i) and melting (ii) is possible at (a) 7.5 ns (b) 1 μs and (c) 40 μs. a particular time and location. Regions indicated by (i) surpass crystallization temperatures and regions indicated by (ii) surpass melting temperatures.

FIG. 3 shows XRD diffractograms of (a) Fe-based ribbon as-cast, and laser-annealed Fe-based ribbons using power settings of (b) 70 mJ (c) 80 mJ (d) 90 mJ (e) 100 mJ and (f) 150 mJ.

FIG. 4 shows the effect of laser annealed Finment samples at 150 mJ. (a) SEM micrograph of the ribbon surface layer (b) selected area diffraction pattern (c) bright field TEM.

FIG. 5 shows SEM micrographs of (a) Fe-based ribbon as-cast, and of laser-annealed Fc-based ribbons using power settings of (b) 70 mJ (c) 80 mJ (d) 90 mJ (c) 100 mJ and (f) 150 mJ.

FIG. 6 shows wide-view magnetic domain images of laser annealed (a) Co-rich ribbons and (b) Fe—Ni ribbons. Also shown are magnetic domain structure of laser annealed FINEMET® ribbons (c) in the laser spot, and (d) domains outside the irradiated area.

FIG. 7 shows temperature variation in the (a) longitudinal and (b) transverse directions for a moving Co-rich ribbon irradiated with a CW laser having a Gaussian beam at various power settings: (i) 0.5 W (ii) 1.0 W (iii) 5 W (iv) 10 W (v) 20 W. x=3.6 cm; σ=5 mm; v=1 cm/sec. Horizontal axis: distance (cm); vertical axis: temp (° C.).

FIG. 8 shows temperature variation in the (a) longitudinal and (b) transverse directions for a moving Co-rich ribbon irradiated with a CW laser having a Gaussian beam at various velocities (i) 0.5 cm/sec (ii) 1.0 cm/sec (iii) 2.5 cm/sec (iv) 5 cm/sec (v) 10 cm/sec. P=10 W; spot radius=5 mm. Horizontal axis: distance (cm); vertical axis: temp (° C.).

FIG. 9 shows temperature variation in the (a) longitudinal and (b) transverse directions for a moving Co-rich ribbon irradiated with a CW laser having a Gaussian beam at various spot radii (i) 1 mm (ii) 5 mm (iii) 10 mm. P=10 W; v=1 cm/sec. Horizontal axis: distance (cm); vertical axis: temp (° C.).

FIG. 10 shows the local instantaneous heating rate in a Co-rich ribbon from a CW laser. P=10 W; spot radius=5 mm; v=1 cm/sec.

FIG. 11 shows the effects on maximum heating rate of varying (a) relative laser/ribbon velocity (horizontal axis; cm/sec) and (b) nominal laser power (horizontal axis; W), which is correlated with the maximum required crystallization temperature. Vertical axis: maximum heating rate (K/min).

### DETAILED DESCRIPTION OF PREFERRED EMBODIMENTS

Provided herein is a method for creating a magnetic domain structure within an initially amorphous material, the method comprising the step of exposing the material to laser irradiation.

Also provided herein is a method for creating a nanocrystalline phase within an amorphous material, the method comprising the step of exposing the material to laser irradiation.

Also provided herein is a method for creating a nanocrystalline phase within an amorphous material, the method comprising the steps of
exposing the material to laser irradiation; and
cooling the irradiated material.

Also provided herein is a method for optimizing a property of a material comprising a nanocrystalline phase within an amorphous matrix, the method comprising the step of exposing the material to laser irradiation. In some embodiments, the phase identity of the nanocrystalline phase is optimized. In some embodiments, the volume fraction of the nanocrystalline phase is optimized. In some embodiments, the grain size of the nanocrystalline phase is optimized.

Also provided herein is a method for varying a magnetic property of a material comprising an initially amorphous material, the method comprising the step of exposing the material to laser irradiation. In some embodiments, the magnetic property is chosen from magnetic domain structure, hysteresis, and eddy currents. In some embodiments, losses due to hysteresis are minimized. In some embodiments, losses due to eddy currents are minimized.

Also provided herein is a method for varying a magnetic property of a material comprising a nanocrystalline phase within an amorphous matrix, the method comprising the step of exposing the material to laser irradiation. In some embodiments, the magnetic property is chosen from magnetic domain structure, hysteresis, and eddy currents. In some embodiments, losses due to hysteresis are minimized. In some embodiments, losses due to eddy currents are minimized.

Also provided herein is a method for altering one or more domain structures within an initially amorphous material, the method comprising the step of exposing the material to laser irradiation.

Also provided herein is a method for altering one or more domain structures within a material comprising a nanocrystalline phase within an amorphous matrix, the method comprising the step of exposing the material to laser irradiation.

In some embodiments, one or more domain structures are altered in a region inside the irradiated area. In some embodiments, one or more domain structures are altered in a region outside the irradiated area.

In some embodiments, the method produces a region inside the irradiated area having a positive magnetostriction coefficient. In some embodiments, the method produces a region inside the irradiated area having a negative magnetostriction coefficient. In some embodiments, the method produces a region inside the irradiated area having a vanishing magnetostriction coefficient.

In some embodiments, the method produces a region outside the irradiated area having a positive magnetostriction coefficient. In some embodiments, the method produces a region outside the irradiated area having a negative magnetostriction coefficient. In some embodiments, the method produces a region outside the irradiated area having a vanishing magnetostriction coefficient.

Also provided herein is a method for converting an initially fully- or partially-crystalline region in a surface layer of a material to an amorphous region, the method comprising the step of exposing the material to laser irradiation. In some embodiments, the region is initially fully crystalline. In some embodiments, the region is initially partly crystalline.

In some embodiments, the optimization is accomplished without application of conventional thermal processing.

In some embodiments, the material is a ribbon. In some embodiments, the ribbon and the laser are moving relative to each other. In some embodiments, the relative velocity of ribbon and laser is about 0.5 cm/sec. In some embodiments, the relative velocity of ribbon and laser is about 1 cm/sec. In some embodiments, the relative velocity of ribbon and laser is about 2 cm/sec. In some embodiments, the relative velocity of ribbon and laser is about 5 cm/sec. In some embodiments, the relative velocity of ribbon and laser is about 10 cm/sec. In some embodiments, the relative velocity of ribbon and laser is about 20 cm/sec. In some embodiments, the relative velocity of ribbon and laser is about 50 cm/sec. In some embodiments, the relative velocity of ribbon and laser is about 100 cm/sec.

In some embodiments, the relative velocity of ribbon and laser is 0.2 cm/sec or faster, optionally 0.5 cm/sec or faster, optionally 1 cm/sec or faster, optionally 2 cm/sec or faster, optionally 3 cm/sec or faster, optionally 5 cm/sec or faster, optionally 10 cm/sec or faster, optionally 20 cm/sec or faster, optionally 50 cm/sec or faster.

In some embodiments, the relative velocity of ribbon and laser is 200 cm/sec or slower, optionally 100 cm/sec or slower, optionally 50 cm/sec or slower, optionally 20 cm/sec or slower, optionally 10 cm/sec or slower, optionally 5 cm/sec or slower, optionally 3 cm/sec or slower, optionally 2 cm/sec or slower, optionally 1 cm/sec or slower, optionally 0.5 cm/sec or slower.

In some embodiments, a single spot on the material is irradiated. In some embodiments, more than one spot on the material is irradiated. In some embodiments, irradiation of the more than one spot on the material is performed simultaneously. In some embodiments, irradiation of the more than one spot on the material is performed non-simultaneously. In some embodiments, irradiation of the more than one spot on the material is performed sequentially.

In some embodiments, the more than one spot on the material are located randomly on the surface of the material. In some embodiments, the more than one spot on the material are located in a pattern on the surface of the material. In some embodiments, the more than one spot on the material are located in a periodic pattern on the surface of the material. In some embodiments, the more than one spot on the material are located in a pattern that is periodic in at least one dimension on the surface of the material. In some embodiments, the more than one spot on the material are located in a pattern that is periodic in two dimensions on the surface of the material.

In some embodiments, the laser irradiation is pulsed laser irradiation. In some embodiments, the laser irradiation is continuous wave (CW) laser irradiation. In some embodiments, the laser irradiation varies in space. In some embodiments, the irradiation is performed with a laser based on a doped corundum crystal. In some embodiments, the irradiation is performed with a laser based on a Nd-doped crystal. In some embodiments, the irradiation is performed with a laser based on an Er-doped crystal. In some embodiments, the irradiation is performed with a laser based on a Tm-doped crystal. In some embodiments, the irradiation is performed with a Q-switched laser. In some embodiments, the irradiation is performed with a Nd-YAG laser. In some embodiments, the irradiation is performed with a Nd—YVO₄ laser. In some embodiments, the irradiation is performed with a Nd-YLF laser. In some embodiments, the irradiation is performed with a CO₂ laser.

In some embodiments, the irradiation is performed at 532 nm. In some embodiments, the irradiation is performed at 585 nm. In some embodiments, the irradiation is performed at 755 nm. In some embodiments, the irradiation is performed at 810 nm. In some embodiments, the irradiation is performed at 1064 nm. In some embodiments, the irradiation is performed at 1320 nm. In some embodiments, the irradiation is performed at 1450 nm. In some embodiments, the irradiation is performed at 9.3 μm. In some embodiments, the irradiation is performed at 10.2 μm. In some embodiments, the irradiation is performed at 10.6 μm.

In some embodiments, the laser spot size is 50 mm in diameter or smaller, optionally 25 mm in diameter or smaller, optionally 20 mm in diameter or smaller, optionally 10 mm in diameter or smaller, optionally 5 mm in diameter or smaller, optionally 1 mm in diameter or smaller, optionally 0.8 mm in diameter or smaller, optionally 0.7 mm in diameter or smaller, optionally 0.6 mm in diameter or smaller, optionally 0.5 mm in diameter or smaller, optionally 0.4 mm in diameter or smaller.

In some embodiments, the spot radius is about 0.5 mm. In some embodiments, the spot radius is about 1 mm. In some embodiments, the spot radius is about 2 mm. In some embodiments, the spot radius is about 5 mm. In some embodiments, the spot radius is about 10 mm. In some embodiments, the spot radius is about 20 mm.

In some embodiments, the spot radius is 0.2 mm or larger, optionally 0.5 mm or larger, optionally 1 mm or larger, optionally 2 mm or larger, optionally 5 mm or larger, optionally 10 mm or larger.

In some embodiments, the spot radius is 20 mm or smaller, optionally 10 mm or smaller, optionally 5 mm or smaller, optionally 2 mm or smaller, optionally 1 mm or smaller.

In some embodiments, the irradiation is performed with a power at or above 50 mJ, optionally at or above 75 mJ, optionally at or above 100 mJ, optionally at or above 125 mJ, optionally at or above 150 mJ.

In some embodiments, the irradiation is performed with a power at or below 400 mJ, optionally at or below 350 mJ, optionally at or below 300 mJ, optionally at or below 250 mJ, optionally at or below 200 mJ.

In some embodiments, the irradiation is performed with a power of about 0.5 W. In some embodiments, the irradiation is performed with a power of about 1 W. In some embodiments, the irradiation is performed with a power of about 5 W. In some embodiments, the irradiation is performed with a power of about 10 W. In some embodiments, the irradiation is performed with a power of about 20 W.

In some embodiments, the irradiation is performed with a power at or above 0.2 W, optionally at or above 0.5 W, optionally at or above 1 W, optionally at or above 5 W, optionally at or above 10 W, optionally at or above 20 W.

In some embodiments, the irradiation is performed with a power at or below 50 W, optionally at or below 25 W, optionally at or below 10 W, optionally at or below 5 W, optionally at or below 2 W, optionally at or below 1 W, optionally at or below 0.5 W.

In some embodiments, the irradiance is 100 mW/mm² or greater, optionally 150 mW/mm² or greater, optionally 200 mW/mm² or greater, optionally 250 mW/mm² or greater, optionally 300 mW/mm² or greater, optionally 400 mW/mm² or greater, optionally 500 mW/mm² or greater.

In some embodiments, the fluence is 200 mJ/mm² or greater, optionally 400 mJ/mm² or greater, optionally 600 mJ/mm² or greater, optionally 800 mJ/mm² or greater, optionally 1000 mJ/mm² or greater.

In some embodiments, the rate of heating at an irradiated spot on the material is 10² K/sec or faster, optionally 5×10² K/sec or faster, optionally 10³ K/sec or faster, optionally 10⁴ K/sec or faster, optionally 5×10⁴ K/sec or faster, optionally 10⁵ K/sec or faster, optionally 5×10⁵ K/sec or faster, optionally 10⁶ K/sec or faster, optionally 5×10⁶ K/sec or faster, optionally 10⁷ K/sec or faster, optionally 5×10⁷ K/sec or faster, optionally 10⁸ K/sec or faster, optionally 5×10⁸ K/sec or faster, optionally 10⁹ K/sec or faster, optionally 5×10⁹ K/sec or faster.

In some embodiments, the rate of heating at an irradiated spot on the material is 10¹⁰ K/sec or slower, optionally 5×10⁹ K/sec or slower, optionally 10⁹ K/sec or slower, optionally 5×10⁸ K/sec or slower, optionally 10⁸ K/sec or slower, optionally 5×10⁷ K/sec or slower, optionally 10⁷ K/sec or slower, optionally 5×10⁶ K/sec or slower, optionally 10⁶ K/sec or slower, optionally 5×10⁵ K/sec or slower, optionally 10⁵ K/sec or slower, optionally 5×10⁴ K/sec or slower, optionally 10⁴ K/sec or slower, optionally 5×10³ K/sec or slower.

In some embodiments, the rate of cooling at an irradiated spot on the material is 10⁴ K/sec or faster, optionally 5×10⁴ K/sec or faster, optionally 10⁵ K/sec or faster, optionally 5×10⁵ K/sec or faster, optionally 10⁶ K/sec or faster, optionally 5×10⁶ K/sec or faster, optionally 10⁷ K/sec or faster, optionally 5×10⁷ K/sec or faster, optionally 10⁸ K/sec or faster, optionally 5×10⁸ K/sec or faster, optionally 10⁹ K/sec or faster, optionally 5×10⁹ K/sec or faster.

In some embodiments, the method further comprises the step of synthesizing an amorphous precursor.

In some embodiments, the method further comprises the step of cooling the irradiated material to ambient temperature. In some embodiments, the step of cooling is accomplished by contacting the irradiated material to atmosphere at ambient temperature. In some embodiments, the rate of cooling is accelerated by contacting the irradiated material to a liquid. In some embodiments, the rate of cooling is accelerated by contacting the irradiated material to a flowing gas blanket.

Also provided herein is a material comprising:
an amorphous matrix; and
one or more nanocrystalline domains.

In some embodiments, the material comprises more than one nanocrystalline domain. In some embodiments, the more than one nanocrystalline domain are located randomly on the surface of the material. In some embodiments, the more than one nanocrystalline domain are located in a pattern on the surface of the material. In some embodiments, the more than one nanocrystalline domain are located in a periodic pattern on the surface of the material. In some embodiments, the more than one nanocrystalline domain are located in a pattern that is periodic in at least one dimension on the surface of the material. In some embodiments, the more than one nanocrystalline domain are located in a pattern that is periodic in two dimensions on the surface of the material.

In some embodiments, the material or matrix is a Fe-based material. In some embodiments, the material or matrix is a Fe—Ni rich material. In some embodiments, the material or matrix is a Co-rich material. In some embodiments, the material or matrix is a Fe—Si—B—Nb—Cu material.

In some embodiments, the material or matrix comprises:
one or more transition metals; and
one or more elements chosen from B, Al, Ga, C, Si, and Ge.

In some embodiments, the material or matrix comprises:
one or more transition metals; and
two or more elements chosen from B, Al, Ga, C, Si, and Ge.

In some embodiments, the material or matrix comprises:
one or more transition metals;
one or more elements chosen from B, Al, and Ga; and
one or more elements chosen from C, Si, and Ge.

In some embodiments, the material or matrix comprises a transition metal chosen from V and Nb. In some embodiments, the material or matrix comprises Nb.

In some embodiments, the material or matrix comprises one or more transition metals chosen from V, Cr, Mn, Fe, Co, Ni, and Cu. In some embodiments, the material or matrix comprises V and one or more transition metals chosen from Cr, Mn, Fe, Co, Ni, and Cu. In some embodiments, the material or matrix comprises V, Cr, Mn, Fe, and one or more transition metals chosen from Co, Ni, and Cu. In some embodiments, the material or matrix comprises V, Cr, Mn, Fe, and a transition metal chosen from Co, Ni, and Cu. In some embodiments, the material or matrix comprises V, Fe, and Co. In some embodiments, the material or matrix comprises V, Fe, and Ni. In some embodiments, the material or matrix comprises V, Fe, and Cu.

In some embodiments, the material or matrix comprises a transition metal chosen from Fe and Ru. In some embodiments, the material or matrix comprises Fe.

In some embodiments, the material or matrix comprises a transition metal chosen from Cu and Ag. In some embodiments, the material or matrix comprises Cu.

In some embodiments, the material or matrix comprises a transition metal chosen from B and Al. In some embodiments, the material or matrix comprises B.

In some embodiments, the material or matrix comprises a transition metal chosen from Si and Ge. In some embodiments, the material or matrix comprises Si.

In some embodiments, the material or matrix comprises Fe, Si, Nb, B, and Cu.

In some embodiments, the material or matrix has the empirical formula Feₓ₂Siₓ₆Nbₓ₇Bₓ₈Cu; wherein:
x2 is between 70 and 80;
x6 is between 15 and 16;
x7 is between 2.5 and 3.5; and
x8 is between 6 and 8.

In some embodiments, x2 is between 72 and 75. In some embodiments, x2 is between 73 and 74. In some embodiments, x2 is 73.5.

In some embodiments, x6 is between 15.2 and 15.8. In some embodiments, x6 is between 15.4 and 15.6. In some embodiments, x6 is 15.5.

In some embodiments, x7 is between 2.8 and 3.2. In some embodiments, x7 is between 2.9 and 3.1. In some embodiments, x7 is 3.

In some embodiments, x8 is between 6.5 and 7.5. In some embodiments, x8 is between 6.8 and 7.2. In some embodiments, x8 is 7.

In some embodiments, the material or matrix has the empirical formula Fe_{73.5}Si_{15.5}Nb₃B₇Cu₁.

In some embodiments, the material or matrix has the empirical formula Feₓ₂Coₓ₃Niₓ₄Siₓ₆Nbₓ₇Bₓ₈Cu; wherein:
x2 is between 70 and 80;
x3 is between 0 and 5;
x4 is between 0 and 5;
x2+x3+x4 is between 70 and 80;
x6 is between 15 and 16;
x7 is between 2.5 and 3.5; and
x8 is between 6 and 8.

In some embodiments, x2 is between 72 and 75. In some embodiments, x2 is between 73 and 74. In some embodiments, x2 is 73.5.

In some embodiments, x3 is between 0 and 2. In some embodiments, x3 is between 0 and 1. In some embodiments, x3 is between 0 and 0.05. In some embodiments, x3 is between 0 and 0.02. In some embodiments, x3 is 0.

In some embodiments, x4 is between 0 and 2. In some embodiments, x4 is between 0 and 1. In some embodiments, x4 is between 0 and 0.05. In some embodiments, x4 is between 0 and 0.02. In some embodiments, x4 is 0.

In some embodiments, x2+x3+x4 is between 70 and 80. In some embodiments, x2+x3+x4 is between 72 and 76. In some embodiments, x2+x3+x4 is between 72.5 and 75. In some embodiments, x2+x3+x4 is between 73 and 74. In some embodiments, x2+x3+x4 is between 73.2 and 73.7. In some embodiments, x2+x3+x4 is between 73.4 and 73.6. In some embodiments, x2+x3+x4 is 73.5.

In some embodiments, x6 is between 15.2 and 15.8. In some embodiments, x6 is between 15.4 and 15.6. In some embodiments, x6 is 15.5.

In some embodiments, x7 is between 2.8 and 3.2. In some embodiments, x7 is between 2.9 and 3.1. In some embodiments, x7 is 3.

In some embodiments, x8 is between 6.5 and 7.5. In some embodiments, x8 is between 6.8 and 7.2. In some embodiments, x8 is 7.

In some embodiments, the material or matrix has the empirical formula Mnₓ₁Feₓ₂Coₓ₃Si₂Nbₓ₇Bₓ₈; wherein:
x1 is between 2.5 and 2.9;
x2 is between 2.5 and 2.9;
x3 is between 72 and 77;
x7 is between 3.5 and 4.5; and
x8 is between 12 and 16.

In some embodiments, x1 is between 2.6 and 2.8. In some embodiments, x1 is between 2.65 and 2.75. In some embodiments, x1 is 2.7.

In some embodiments, x2 is between 2.6 and 2.8. In some embodiments, x2 is between 2.65 and 2.75. In some embodiments, x2 is 2.7.

In some embodiments, x1 is between 2.2 and 2.4. In some embodiments, x1 is between 2.25 and 2.35. In some embodiments, x1 is 2.3.

In some embodiments, x2 is between 2.2 and 2.4. In some embodiments, x2 is between 2.25 and 2.35. In some embodiments, x2 is 2.3.

In some embodiments, x3 is between 73 and 76. In some embodiments, x3 is between 73.5 and 75.5. In some embodiments, x3 is 74.6.

In some embodiments, x3 is between 74 and 77. In some embodiments, x3 is between 74.5 and 76.5. In some embodiments, x3 is 75.4.

In some embodiments, x7 is between 3.75 and 4.25. In some embodiments, x7 is between 3.9 and 4.1. In some embodiments, x7 is 4.

In some embodiments, x8 is between 13 and 15. In some embodiments, x8 is between 13.5 and 14.5. In some embodiments, x8 is 14.

In some embodiments, x1+x2+x3 is between 70 and 90. In some embodiments, x1+x2+x3 is between 75 and 85. In some embodiments, x1+x2+x3 is between 78 and 82. In some embodiments, x1+x2+x3 is between 79 and 81. In some embodiments, x1+x2+x3 is between 79.5 and 80.5. In some embodiments, x1+x2+x3 is 80.

In some embodiments, x1−x2 is between −0.3 and 0.3. In some embodiments, x1−x2 is between −0.2 and 0.2. In some embodiments, x1−x2 is between −0.1 and 0.1. In some embodiments, x1−x2 is between −0.05 and 0.05. In some embodiments, x1=x2.

In some embodiments, the material or matrix has the empirical formula CO_{74.6}Fe_{2.7}Mn_{2.7}Nb₄B₁₄Si₂.

In some embodiments, the material or matrix has the empirical formula Crₓ₀Mnₓ₁Feₓ₂Coₓ₃Niₓ₄Si₂Nbₓ₇Bₓ₈; wherein:
x0 is between 0 and 5;
x1 is between 2.5 and 2.9;
x2 is between 2.5 and 2.9;
x3 is between 72 and 77;
x4 is between 0 and 5;
x0+x1+x2+x3+x4 is between 70 and 90;
x7 is between 3.5 and 4.5; and
x8 is between 12 and 16.

In some embodiments, x0 is between 0 and 2. In some embodiments, x0 is between 0 and 1. In some embodiments, x0 is between 0 and 0.05. In some embodiments, x0 is between 0 and 0.02.

In some embodiments, x1 is between 2.6 and 2.8. In some embodiments, x1 is between 2.65 and 2.75. In some embodiments, x1 is 2.7.

In some embodiments, x2 is between 2.6 and 2.8. In some embodiments, x2 is between 2.65 and 2.75. In some embodiments, x2 is 2.7.

In some embodiments, x1 is between 2.2 and 2.4. In some embodiments, x1 is between 2.25 and 2.35. In some embodiments, x1 is 2.3.

In some embodiments, x2 is between 2.2 and 2.4. In some embodiments, x2 is between 2.25 and 2.35. In some embodiments, x2 is 2.3.

In some embodiments, x3 is between 73 and 76. In some embodiments, x3 is between 73.5 and 75.5. In some embodiments, x3 is 74.6.

In some embodiments, x3 is between 74 and 77. In some embodiments, x3 is between 74.5 and 76.5. In some embodiments, x3 is 75.4.

In some embodiments, x4 is between 0 and 2. In some embodiments, x4 is between 0 and 1. In some embodiments, x4 is between 0 and 0.05. In some embodiments, x4 is between 0 and 0.02.

In some embodiments, x7 is between 3.75 and 4.25. In some embodiments, x7 is between 3.9 and 4.1. In some embodiments, x7 is 4.

In some embodiments, x8 is between 13 and 15. In some embodiments, x8 is between 13.5 and 14.5. In some embodiments, x8 is 14.

In some embodiments, x0+x1+x2+x3+x4 is between 70 and 90. In some embodiments, x0+x1+x2+x3+x4 is between 75 and 85. In some embodiments, x0+x1+x2+x3+x4 is between 78 and 82. In some embodiments, x0+x1+x2+x3+x4 is between 79 and 81. In some embodiments, x0+x1+x2+x3+x4 is between 79.5 and 80.5. In some embodiments, x0+x1+x2+x3+x4 is 80.

In some embodiments, x1−x2 is between −0.3 and 0.3. In some embodiments, x1−x2 is between −0.2 and 0.2. In some embodiments, x1−x2 is between −0.1 and 0.1. In some embodiments, x1−x2 is between −0.05 and 0.05. In some embodiments, x1=x2.

In some embodiments, the material or matrix has the empirical formula (Feₓ₂Coₓ₃Niₓ₄)₈₀Si₂Nbₓ₇Bₓ₈; wherein:
x2 is between 65 and 75;
x3 is between 0 and 5;
x4 is between 26 and 34;
x7 is between 3.5 and 4.5; and
x8 is between 12 and 16.

In some embodiments, x2 is between 68 and 72. In some embodiments, x2 is between 69 and 71. In some embodiments, x2 is 70.

In some embodiments, x3 is between 0 and 2. In some embodiments, x3 is between 0 and 1. In some embodiments, x3 is between 0 and 0.05. In some embodiments, x3 is between 0 and 0.02. In some embodiments, x3 is 0.

In some embodiments, x4 is between 28 and 32. In some embodiments, x4 is between 29 and 31. In some embodiments, x4 is 30.

In some embodiments, x7 is between 3.75 and 4.25. In some embodiments, x7 is between 3.9 and 4.1. In some embodiments, x7 is 4.

In some embodiments, x8 is between 13 and 15. In some embodiments, x8 is between 13.5 and 14.5. In some embodiments, x8 is 14.

In some embodiments, the material or matrix has the empirical formula (Fe₇₀Ni₃₀)₈₀Si₂Nb₄B₁₄.

In some embodiments, the material or matrix has the empirical formula (Feₓ₂Niₓ₄)₈₀Nb_{0.5}Bₓ₈; wherein:
x2 is between 65 and 75;
x4 is between 28 and 34;
x8 is between 12 and 16.

In some embodiments, x2 is between 68 and 72. In some embodiments, x2 is between 69 and 71. In some embodiments, x2 is 70.

In some embodiments, x4 is between 28 and 32. In some embodiments, x4 is between 29 and 31. In some embodiments, x4 is 30.

In some embodiments, x8 is between 13 and 15. In some embodiments, x8 is between 13.5 and 14.5. In some embodiments, x8 is 14.

In some embodiments, the material or matrix has the empirical formula (Feₓ₂Niₓ₄)₈₆B₁₄, wherein:
x4 is between 0 and 0.5; and
x2+x4 is between 0.9 and 1.1.

In some embodiments, x4 is between 0 and 0.4. In some embodiments, x4 is between 0 and 0.35. In some embodiments, x4 is between 0 and 0.3. In some embodiments, x4 is chosen from 0, 0.1, 0.2, and 0.3.

In some embodiments, x2+x4 is between 0.95 and 1.05. In some embodiments, x2+x4 is between 0.98 and 1.02. In some embodiments, x2+x4 is between 0.99 and 1.01. In some embodiments, x2+x4 is 1.

Also provided are embodiments wherein any embodiment above may be combined with any one or more of these embodiments, provided the combination is not mutually exclusive.

As used herein, two embodiments are “mutually exclusive” when one is defined to be something which is different than the other.

### Laser Irradiation

Certain methods disclosed herein utilize laser irradiation. Without wishing to be bound by theory, particulars of the heating process driven by laser irradiation can be expected to influence the characteristics of the material.

During pulsed laser irradiation, the laser energy density will be expected to decrease exponentially in the radial direction with a maximum at the laser spot center, leading to greater temperatures at the center and a temperature gradient from the center towards the irradiated area perimeter. In addition, the laser beam irradiation will be expected to produce a stress distribution associated with its Gaussian profile, developed within the residual tensile stress profile of the quenched ribbon produced during casting (14). Resulting inhomogeneous stress profiles are tensile at the center and compressive at the perimeter of irradiated areas (2, 10). Temporally and spatially dependent temperature and stress profiles can alter free volume, nucleation rate, and diffusion kinetics leading to rapid crystallization events and alternative pathways towards the nanocrystalline phase. In addition, the relatively high energy density of a pulsed laser, combined with shallow penetration depths into the amorphous ribbon, can be expected to lead to exceedingly high temperatures on the top surface during initial irradiation. These unique thermophysical effects upon laser interaction with amorphous ribbons can affect the evolution of phase transformations, including: (a) thermal ablation, (b) laser melting followed by rapid re-solidification, and (c) laser heating above the crystallization temperature of the amorphous alloy.

Similar effects are expected for continuous wave (CW) laser irradiation, with the major difference being that energy is applied continuously during operation, rather than in a sequence of pulses. The difference in thermal behavior between the two modes of operation will depend on the pulse repetition rate. It will be expected that, for a relatively slow phenomenon such as thermal energy transfer, application of laser power in pulses having a high repetition rate will produce a similar effect as would steady-state application of laser power from a CW laser. In contrast, slower repetition rates for a pulsed laser may produce meaningful differences in thermal behavior, especially in smaller volumes of material. Conversely, reducing the power of the pulses, while extending their duration and minimizing the delay between pulses, will approach continuous wave processing.

### Annealing Mechanisms

Certain methods disclosed herein employ the cooling of a material subsequent to heading of the material by laser irradiation. Without wishing to be bound by theory, the particulars of the cooling process can be expected to influence the characteristics of the material.

Laser treatments of amorphous metals have been previously reported to result in surface melting and re-solidification without crystallization of the initial glassy structure due to the high cooling rates attained (15-17). However, solidification behavior of a surface-melted material is more complex than solidification developed during melt spinning or planar flow casting techniques used for the fabrication of magnetic amorphous ribbons. In the case of the pulsed laser processed samples, for which a local surface melting and re-solidification process has occurred, a tensile stress is expected near the center of the laser irradiated region while compressive stresses would be generated near the interface and surrounding the exterior of the direct laser irradiated region.

The crystallization of soft magnetic amorphous ribbons is typically assumed to be diffusion controlled, with a nucleation rate governed by both thermodynamic and kinetic aspects associated with atomic diffusion (2, 20). In traditional isothermal furnace annealing where heating rates are relatively slow (i.e., on the order of a few K/s) diffusion processes and structural relaxation of internal stresses induced following the production of amorphous ribbons through rapid solidification take place simultaneously upon annealing the amorphous precursor. The scenario is different in laser annealing where extremely high heating rates are involved along with localized thermal stresses which impact the amount of available free volume, yielding modified kinetics (2,10). Primary crystallization of amorphous metallic glasses occurs by two thermally activated processes, namely, nucleation and growth (21). Growth rates increase with increasing temperature below the melting temperature, whereas temperatures of maximum nucleation rate are attained in an intermediate range between melting and glass transition temperatures (1,22-24). In Fe-based compositions, primary crystallization to a BCC or derivative phase is observed followed by the formation of boride based intermetallic phases at higher temperatures (25). For flash annealing with high heating rates of ~10²-10³K/s, nucleation rate has been proposed to be enhanced by rapid heating to temperatures approaching and above the glass transition temperature (2,24,26). Modified kinetics resulting from the detailed thermal-mechanical state of the amorphous precursors as a function of time associated with pulsed laser processing can also potentially result in deviations from the expected primary and then secondary crystallization processes for standard annealing. Particularly due to top surface melting, chemical partitioning and enhanced kinetics immediately adjacent to the laser irradiated surface may exhibit substantially modified devitrification behavior requiring substantial further detailed study moving into the future.

In addition to spatially varying thermal profiles and associated phase transformations, induced residual stresses are expected within the surrounding amorphous ribbon for pulsed laser processed ribbons. Residual compressive stresses can extend far beyond the irradiated region for regions of the sample in which the low peak temperatures achieved during thermal processing indicate that crystallization is not possible, and will depend upon the detailed spatio-temporal thermal profile during laser irradiation as well as any phase transformations which occur during the subsequent thermal conduction. Depending upon the magnetostriction coefficient, residual stresses can also yield microscopic and macroscopic anisotropies due to the magnetoelastic coupling (2, 20). Induced magnetoelastic anisotropies by means of local laser annealing associated with both compressive and tensile stresses allow for non-uniform stress distributions that can have a substantial impact on magnetic domain structure.

### Definitions

As used herein, the terms below have the meanings indicated.

The term “alloy”, as used herein, generally refers to a material comprising two or more elements, at least one of which is a metal. An alloy can have a substantially uniform composition. An alloy can have a nonuniform composition. An alloy can comprise two or more phases. An alloy can be substantially crystalline, substantially amorphous, or contain both amorphous and crystalline domains. In some embodiments, an alloy comprises two or more metals. In some embodiments, an alloy comprises a nonmetal. In some embodiments, an alloy comprises one or more transition metals.

The term “domain”, as used herein, generally refers to a contiguous region of a material having uniform chemical composition and/or structure. The size of a domain is without restriction, and a domain can therefore have dimensions on the millimeter, micrometer, and nanometer scales. The dimensions of a domain in different spatial directions need not be the same, and a domain can therefore have one or two dimensions of a different scale than the others, i.e., can assume the shape of a film or rod. In some embodiments, the magnetic moments of atoms within a domain have the same orientation.

The term “nano”, as used herein, generally refers to a size of 1 nanometer or more, and less than 1 μm.

The term “matrix”, as used herein, generally refers to the dominant phase in a multi-phase material.

The term “phase”, as used herein, generally refers to one or more domains of a material having substantially identical structure. A phase generally has substantially uniform chemical composition. A phase can comprise two or more elements having substantially the same size but having different electronic properties, such as Si doped with P, or Si doped with Al.

A phase can be crystalline or amorphous. A phase can consist of two or more domains. A phase can consist of two or more crystalline domains. A phase can consist of two or more amorphous domains.

### List of Abbreviations

BCC=body-centered cubic; FCC=face-centered cubic; HCP=hexagonal close packed; SEM=scanning electron microscopy; TEM=transmission electron microscopy. The invention is further illustrated by the following examples.

### Example 1

Finite element simulations: variations from the surface of laser spot center To gain insights into the spatial and temporal evolution of the thermal history of a sample during pulsed laser irradiation, finite element simulations of the heat transfer were performed. Material parameters used were taken from the published literature and are appropriate for representative FINEMET® amorphous alloys (2). A FINEMET® ribbon thickness of 15 μm was assumed along with a singular laser spot radius of 0.35 mm, a Gaussian laser pulse of total energy 100 mJ, and duration of 3 ns. Simulations were performed using the heat transport module of COMSOL 5.6 for a cylindrically symmetric geometry and including conduction along with thermal radiation from both surfaces. For illustrative purposes, the heat of crystallization (186 J/kg, exothermic) and melting (55 J/kg, endothermic) have also been included by adding temperature-dependent terms to the heat capacity to clarify potential impacts on the temporal and spatial thermal profile. Gaussian terms are added to an otherwise constant heat capacity to model these terms, with integrated areas corresponding to the heats of melting and crystallization. Simulation results are substantially dependent upon surface reflectivity, and in the simulations presented here, a reflectivity of 0.9 was assumed representing the upper limit of reasonable values attainable. A peak surface temperature of more than 2000 K is attained, and for reduced surface reflectivity values the peak temperature would be larger, consistent with predictions of a surface temperature high enough for surface melting and also with experimental results reported (below).

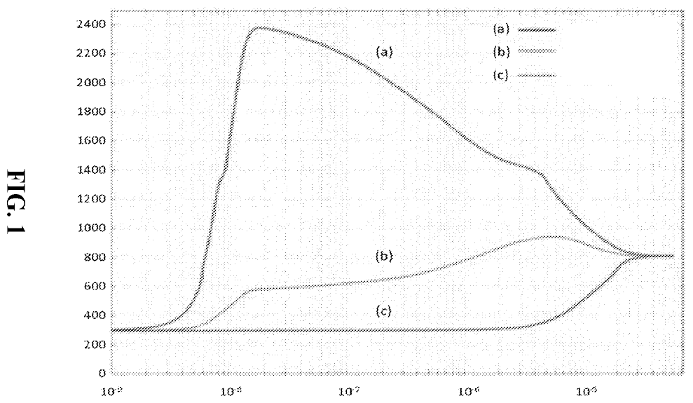

FIG. 1 shows the surface temperature at the laser spot center just below the surface (0.5 μm; FIG. 1a) as a function of the logarithm of time. For t<20 ns the temperature increases monotonically with time, with an increased slope at a temperature corresponding to exothermic crystallization, and with a ledge at a temperature corresponding to melting. The estimated maximum rate of change of temperature is extremely rapid (~10¹¹ K/s), clearly indicating heating rates inaccessible with other techniques. The cooling rate at 0.5 μm depth (approximately the penetration depth) below the surface is on order of 10⁹ K/s, much faster than traditional rapid quenching techniques. Although potential impacts of the heat of transformation are modeled within the results of FIG. 1, these details do not dramatically impact predicted heating rates. For comparison, simulation results are also presented for several locations deeper within the ribbon (~7.5 μm, FIG. 1b) and on the back ribbon surface (~15 μm, FIG. 1c). Peak temperatures remain below melting but do reach typical primary crystallization and secondary crystallization temperatures, indicating that nanocrystallization may be possible.

### Example 2

Finite Element Simulations: Variations Lateral from Laser Spot Center

Lateral variations on the surface of the FINEMET® ribbon of the previous example were estimated. For visualization purposes, the volume of material that can potentially be “crystallized” and “melted”, based on peak temperature at a particular location and time, was calculated by developing time—temperature profiles of the type illustrated in the previous example.

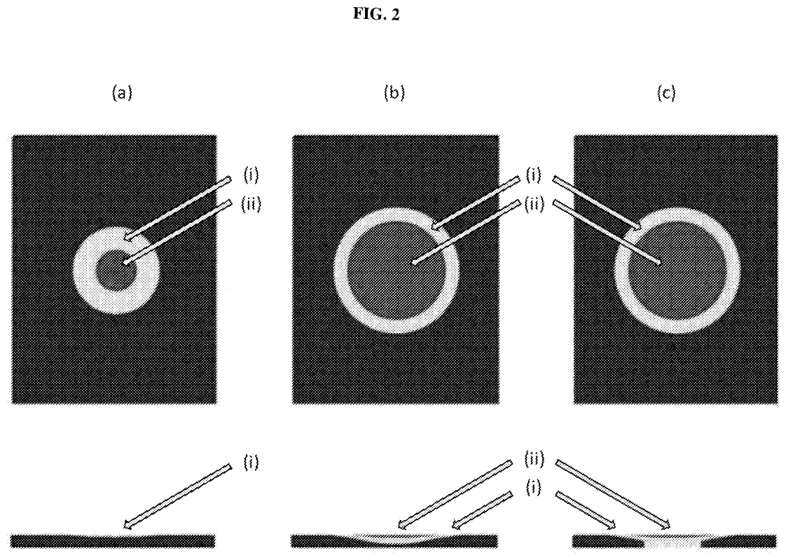

The simulation of FIG. 2a (t=7.5 ns; before the peak of the laser pulse) shows that surface melting is possible in a region labelled (ii), within the laser irradiated spot size. This region is surrounded by a larger surface ring of material, labelled (i), still within the laser irradiated region, only reaching temperatures corresponding to crystallization.

The simulation of FIG. 2b (t=1 μs) shows that region (ii), in which both melting and crystallization temperatures are reached, has been enlarged, and region (i), in which crystallization temperatures are reached, has penetrated below the surface and extended slightly beyond the diameter of the original laser irradiation spot, presumably due to thermal diffusion.

The simulation of FIG. 2c (t=40 μs) shows that the size of region (ii) is largely unchanged, and region (i) extends through the entire layer thickness immediately beneath the irradiated surface.

These simulations can be further understood based on heat transfer characteristics of the material and the rate of heat transfer through thermal conduction. For example, the time required for a heat pulse on the top surface to reach half of the maximum value on the bottom surface is given by:

$${t}_{1 / 2} = 0.1388 {ρ}_{m} {C}_{p} {d}^{2} / k$$

where μₘ is the mass density, Cₚ the heat capacity, d the layer thickness, and k the thermal conductivity. For this case the penetration time is 12.5 μs, far longer than the pulse length. As a result, the laser pulse establishes an initial surface temperature distribution above the melting temperature resulting in melting and re-solidification at rates that an amorphous surface layer is still retained, and without substantial thermal diffusion within the bulk of the amorphous ribbon. Following conclusion of the laser pulse, the heat then diffuses throughout the ribbon such that a volume of material surrounding the initial irradiated region can ultimately approach or exceed typical crystallization temperatures at exceedingly high heating rates. It is reasonable to expect spatially varying devitrification and formation of nanocrystalline domains which can also deviate from expectations for more conventional thermal processing conditions.

### Example 3

### Laser Annealing of Fe-Based Ribbons

Amorphous ribbons with nominal composition Fe_{73.5}Si_{15.5}Nb₃B—Cu₁ were annealed with a Q-smart pulsed Nd-YAG (λ=1064 nm) with laser beam diameter of ~0.6 mm. Laser power was varied from 50-150 mJ and the time delay associated with each laser power was calculated using full-width-half-maximum (FWHM) of the laser output pulse.

Microstructure and crystalline phases after laser annealing were characterized using x-ray diffraction, with an XRD Bruker D8 Discover Diffractometer with Cu K radiation (λ=0.15418 nm) and a slit size of 0.2 mm. Ribbon samples were attached to the diffractometer at which each scan was made over the 2 theta angular range between 30-90° with a step size of 0.025° and scanning speed of 0.45°/sec. The length of irradiated area (L) on the sample was estimated from the height of the x-ray beam and the incident 2 theta angular range (30-90°), to be on the order of 0.4-0.2 mm. X-ray point optics were also adjusted using a collimator with an aperture of 1 mm to focus the beam on the irradiated laser spot.

The x-ray spot size on the sample surface is approximately 0.2 mm×1 mm in an area centered within the laser irradiated spot of ~0.6 mm diameter, such that it spans beyond the irradiated laser spot processed region into the surrounding region impacted by thermal diffusion.

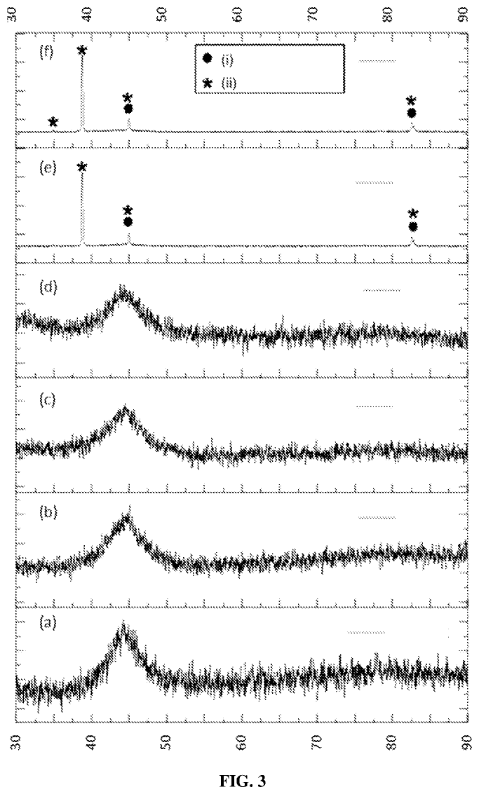

FIG. 3 shows XRD patterns of as-cast and laser annealed Fe-based ribbons at different laser power settings. Diffractograms for samples annealed at laser power level below 100 mJ (FIGS. 3b-d) show them as remaining fully amorphous. Diffractograms for samples treated at higher laser power (i.e., ≥100 mJ; FIGS. 3e, f) present XRD peaks indicative of the formation of nanocrystalline domains.

For conventional annealing, the formation of primary nanocrystalline domains is followed by boride phases after reaching secondary crystallization temperatures as described in the following sequence (1, 4): Amorphous [T<500° C.]→amorphous+α-Fe(Si) [510° C.<T>590° C.]→Fe₂B/Fe₂₃B₆ [T>590° C.]. These phase transformation temperatures are typically associated with characteristic times >1s and onset temperatures can be associated with activation energies through kinetics associated with heating rates.

Ribbons annealed by the methods of this example do not show the conventional evolution of phases expected as a function of the increased pulsed laser intensity. These observed crystalline phases can instead be indexed to body centered cubic α-Fe (i) and boride-based intermetallic (ii) phases. Of particular note is the presence of a dominant peak at 2θ~38° which, in combination with the additional peaks present, may be indicative of a dominant ternary intermetallic nominally identified as Fe₅SiB₂, preferentially formed at the surface of the ribbons with a degree of crystallographic texture (13).

### Example 4

### Electron Microscopy of Annealed Fe-Based Ribbons

Scanning electron microscopy (SEM) analysis of the annealed ribbons was performed using a Thermo Fisher Scientific Apreo instrument. Sample preparation for transmission electron microscopy (TEM) was performed using dual-beam focused ion beam (FIB) FEI Scios system through lift-out techniques, with samples taken from the top ribbon surface at center and near edges of a laser irradiated region. TEM imaging was performed in bright-field and selected area diffraction modes using a JEOL JEM 2100F TEM.

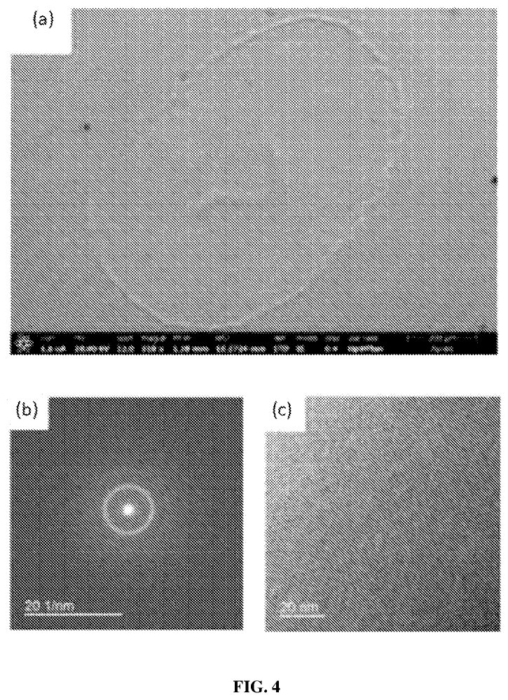

SEM analysis shows evidence of local surface melting at the center of the laser irradiated region (FIG. 4a). This near-surface melting through the observed contrast is consistent with slight surface deformation unaccompanied by distortion of the basic topography of the initial underlying sample surface. An exception is seen at the edge of the molten zone, in which an accumulation of material can be observed.

Estimated peak temperatures decrease as a function of distance from the center towards the edge of laser spots due to decreased laser intensity resulting in substantially different thermal profiles throughout the laser pulse irradiated region.

Finite element simulations suggest that the melting temperature of the amorphous ribbon can be exceeded during the initial laser pulse irradiation at the top surface, such that melting at the surface followed by rapid solidification fast enough to quench to an amorphous solid appears feasible. The presence of amorphous structure for the top surface of the ribbon both near edges and at the center of the laser irradiated region was confirmed by selected area diffraction (FIG. 4b) and TEM imaging (FIG. 4c), consistent with this assertion. For surrounding regions below the top surface and surrounding the primary laser irradiation region, substantially reduced peak temperatures below melting may instead yield devitrification with transformation pathways deviating from more conventional thermal processing due to residual stresses and exceptionally high heating rates.

According to finite element simulations described in more detail above, heating and cooling rates at the top surface can be on the order of 10⁹ and 10⁸ K/s; respectively, greater than cooling rates attainable through the rapid solidification processing during the planar flow casting of amorphous ribbons (10⁵-10⁶ K/s) 1 as well as heating rates of laser annealed ribbons by means of continuous-wave laser processing (10⁵ K/s)^{2,10}. These exceptionally high heating and cooling rates are expected to severely restrict diffusion length scales.

### Example 5

### Texture Analysis of Surface Roughness by SEM

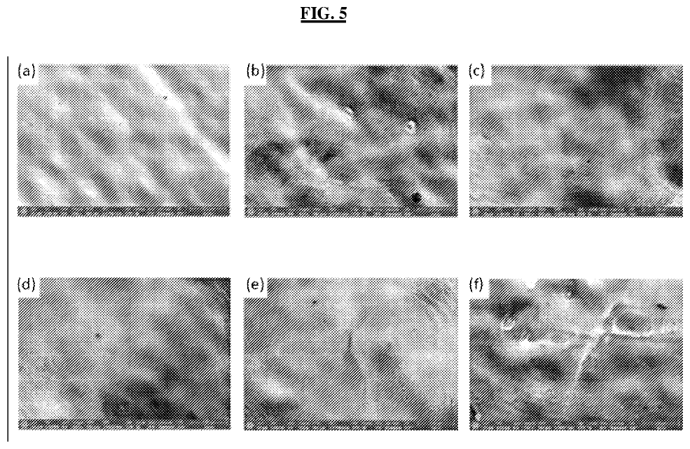

SEM micrographs were collected from the center of the laser irradiated spot on the annealed Fe-based ribbons. Surface of the as-cast amorphous ribbons (FIG. 5a) shows a typical surface roughness consisting of slowly varying undulations on the length scale of ~50-100 microns in the plane and submicron to several microns vertically, typically observed for the air side of as-cast amorphous ribbons. Micrographs collected from ribbons exposed to laser pulsing at power levels of 70, 80, and 90 mJ (FIGS. 5b, c, d, respectively) display an increased number of finer length scale undulations at the scale of several microns on the sample surface in the irradiated regions and particularly localized around the outer diameter of the laser irradiated spot where compressive stresses would be dominant. Such features become more prominent in micrographs ribbons exposed to laser power of 100 and 150 mJ (FIGS. 5e and f, respectively), even showing evidence of tensile surface fractures at the laser irradiated spot center in some cases.

### Example 6

### Magnetic Domain Images: Co-Rich, Ni-Rich, and FINEMET® Ribbons

The following ribbons were laser-annealed using the procedures of Example 1:

| | |
|---|---|
| Co-rich | CO_{74.6}Fe_{2.7}Mn_{2.7}Nb₄B₁₄Si₂ |
| Ni-rich | (Fe₇₀Ni₃₀)₈₀Nb₄Si₂B₁₄ |
| FINEMET ® | Fe_{73.5}Si_{15.5}Nb₃B₇Cu₁ |

Magnetic domain images were observed by magneto-optical Kerr effect (MOKE) microscopy (Evico Magnetics GmbH).

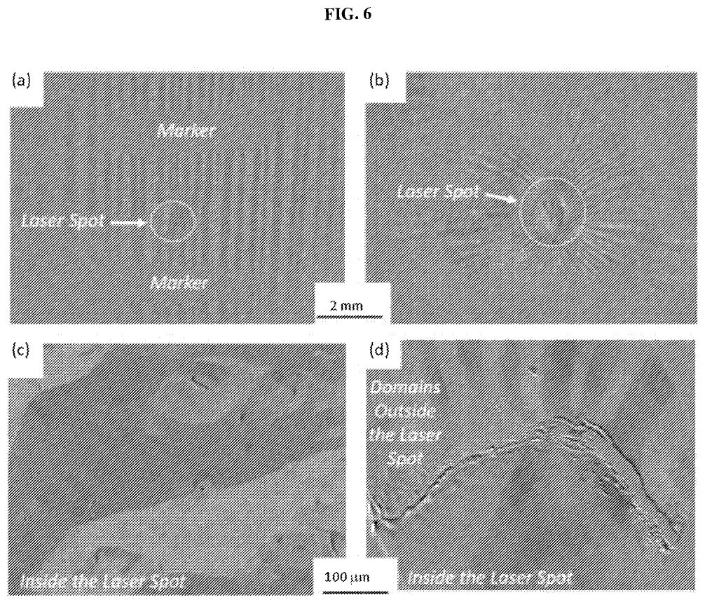

FIG. 6a shows a wide-view magnetic domain image of a laser annealed Co-rich ribbon. These ribbons exhibit relatively narrow stripe domains due to the residual tensile stress in the as-cast ribbon and the small negative magnetostriction coefficient.

Fe-based ribbons with a positive magnetostriction coefficient exhibit a network of domains running primarily parallel to the ribbon axis away from laser processed spots.

Laser annealing of Fe—Ni based alloy ribbons with relatively large positive magnetostriction (~18-23 ppm) (27, 28) shows a clear impact on domain structures in surrounding regions.

FIG. 6b shows a wide-view magnetic domain image of a laser annealed FeNi-ribbon. Fc-Ni domains radiate outward from the laser spot following laser irradiation, confirming residual compressive stresses.

Domain patterns inside spot regions in laser annealed FINEMET® ribbons (FIG. 6c) show larger domains compared to regions outside the spot (FIG. 6d), potentially due to nucleated Fe—Si grains with negative magnetostriction within the sample bulk thereby reducing magnetostriction coefficient.

These observations demonstrate feasibility for periodic localized thermal-physical processing through pulsed laser methods to achieve spatially varied phase transformations and combined domain structure engineering.

### Example 7

The goal of this simulation is to explore the general effects of basic process parameters such as beam power, relative velocity between ribbon and laser, spot size, etc. on the instantaneous heating profile during laser annealing of soft magnetic ribbon. The kinetics of laser annealing differ greatly from conventional annealing where crystallization temperatures are approximately known. Therefore, where practical, existing models of crystallization kinetics were adapted and incorporated to predict local crystallization temperatures and thus provide more a more accurate reflection of volume fractions crystallized.

The present study is directed to continuous wave (CW) lasers. In general, CW lasers have much lower energy densities than pulsed lasers, which should result in heating profiles that are less susceptible to melting or ablation of the ribbon surface than pulsed lasers. Furthermore, CW lasers would be more readily compatible with continuous processing than would pulsed lasers.

Simulation was carried out using COMSOL 6.1 using the Deposited Beam Power feature of the Heat Transfer in Solids module to model the laser beam. For this study, a wavelength of wavelength 1060 μm was used; other wavelengths can be explored using this method. Crystallization parameters calculated using the Domain ODEs and DAEs module. A Gaussian beam was assumed, traveling along the longitudinal axis of the ribbon (or equivalently, a moving ribbon relative to a stationary beam) at a normal orientation to the ribbon surface. All simulations reported so far assume a Co-rich ribbon composition (properties are provided in Table 1), but modeling of Fe-based and Fe—Ni based chemistries is also possible provided material data is available. Thermal transport was allowed to proceed by conduction within the ribbon and radiation to the surroundings. The ambient temperature was 20° C.

TABLE 1
Material properties of a representative Co-rich ribbon

| Relative | Electrical | Density | Thermal | Heat capacity | |
|---|---|---|---|---|---|
| permeability | conductivity | (ρ) | conductivity | (constant P) | Permittivity |
| (μᵣ) @ 4 kA/m | (σ) (10⁵ S/m) | (kg/m³) | (k) (W/mK) | (Cₚ) (J/kgK.) | (ε) (-) |
| 100 | 7.65 | 7900 | 8.2 | 500 | 0.20 |

Initial simulations investigated the basic effects of varying nominal laser power, relative velocity between laser and ribbon, and beam diameter on the temperature distributions in a ribbon.

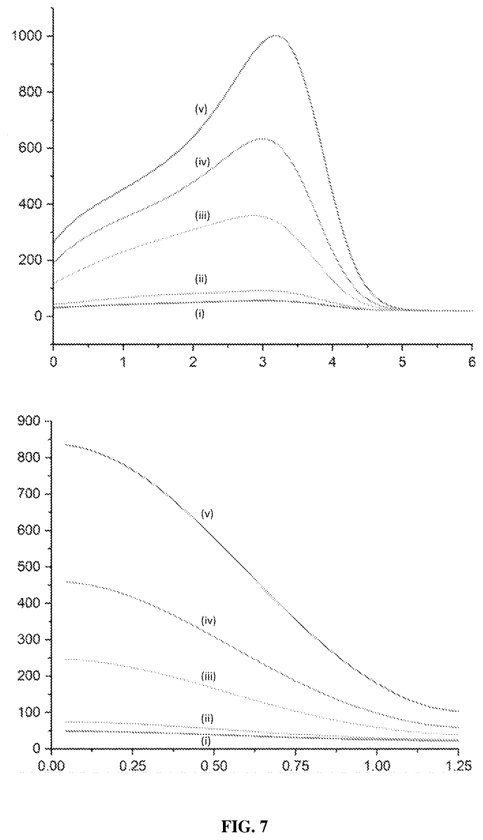

FIG. 7 shows the effect of varying nominal deposited power; as expected, low beam powers result in lower peak temperatures and a more spatially uniform profile, while higher beam powers result in higher peak temperatures and more localized heating.

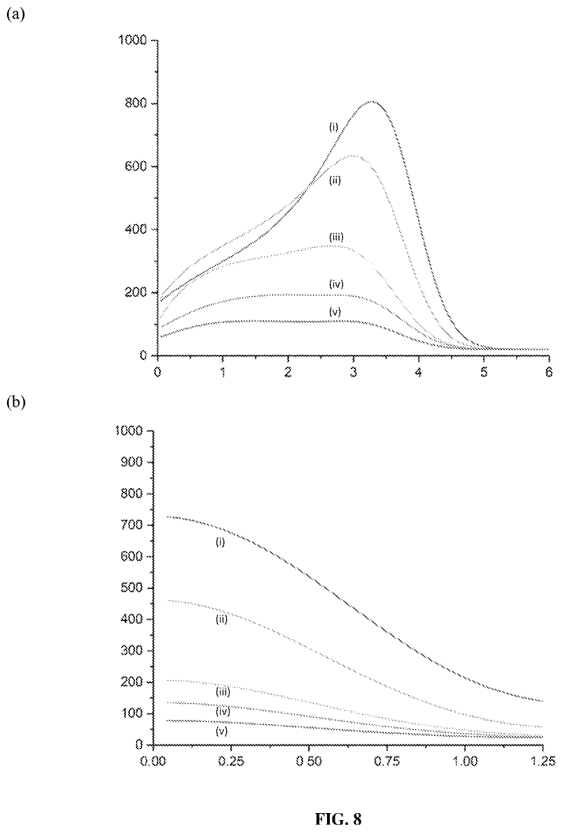

Similar profiles are observed in FIG. 8 for a fixed 10 W beam power traveling at variable velocity.

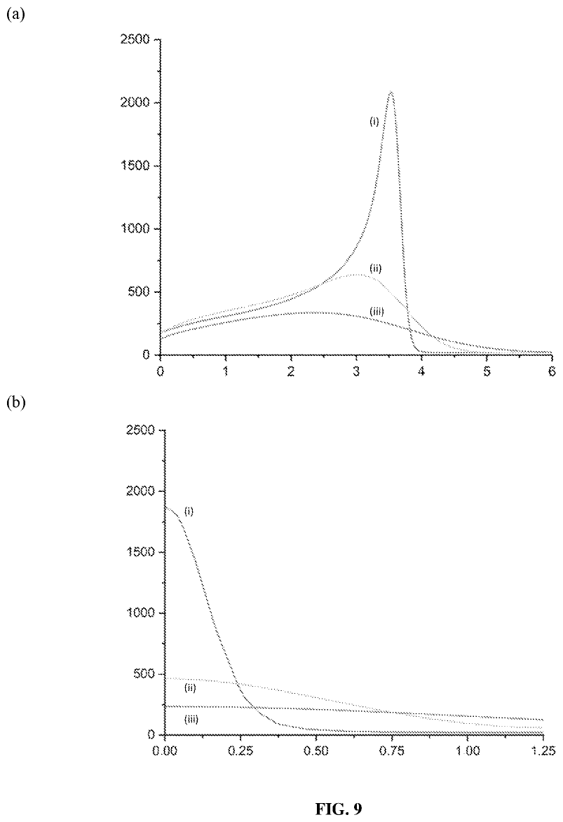

By far the strongest effect on the temperature profile is observed when varying spot size, as shown in FIG. 9. The peak temperature rapidly increases with decreasing spot size. This stronger dependence is consistent with the fact that while the energy deposited is linear in the laser power and travel velocity (assuming negligible change in penetration depth), it is quadratic with the radius of the spot size. The selected parameter space shows promise for a wide degree of control of the thermal profile around the expected primary crystallization temperature range (approx. 400-550° C.). Conversion of the temperature profiles into predictions of local volume fraction crystallized requires incorporation of crystallization kinetics, as is explained below.

There is a strong dependence of crystallization temperature on local heating rate (high heating rate generally results in enhanced crystallization temperatures) (29). In laser annealing, heating rates for laser annealing are both extremely high and spatially nonuniform, as compared to those for conventional annealing. Therefore, crystallization behavior under conventional annealing conditions cannot be expected to correlate well crystallization behavior from laser annealing. Therefore, models of crystallization kinetics which account for the heating rate from laser annealing are a necessary addition to the model.

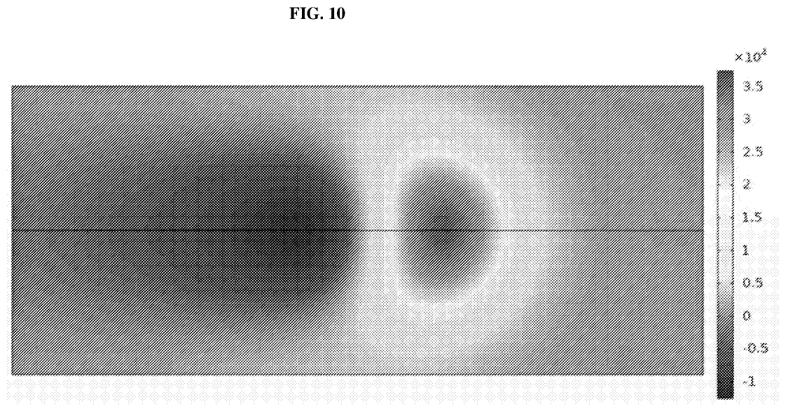

Incorporation of a spatially local crystallization model which is generalized enough to handle arbitrarily large and time-varying heating rates is not a trivial task. FIG. 10 shows the distribution of local instantaneous heating rates during a laser annealing process simulated in COMSOL for a Gaussian beam with σ=5 mm, P=10 W, v=1 cm/s. For this parameter combination, the maximum heating rates observed when the system is in a steady-state mode (i.e. the laser is not turning on/turning off and the ribbon is moving at constant velocity) is ~10⁴ K/s, but this varies significantly as a function of position. However, by making key assumptions, the problem may be simplified sufficiently to create a reasonable approximation of local crystallization. The first key assumption made was that the activation energy Eₐ (KJ/mol) for crystallization is invariant with temperature to arbitrarily large heating rate (29). Several models exist for determining the activation energy of a crystallization process, each with their own limitations, but for simplicity we selected the well-known Kissinger model (30):

$$ln ( β / {T}_{x 1}^{2} ) = - Ea / {RT}_{x 1} + C$$

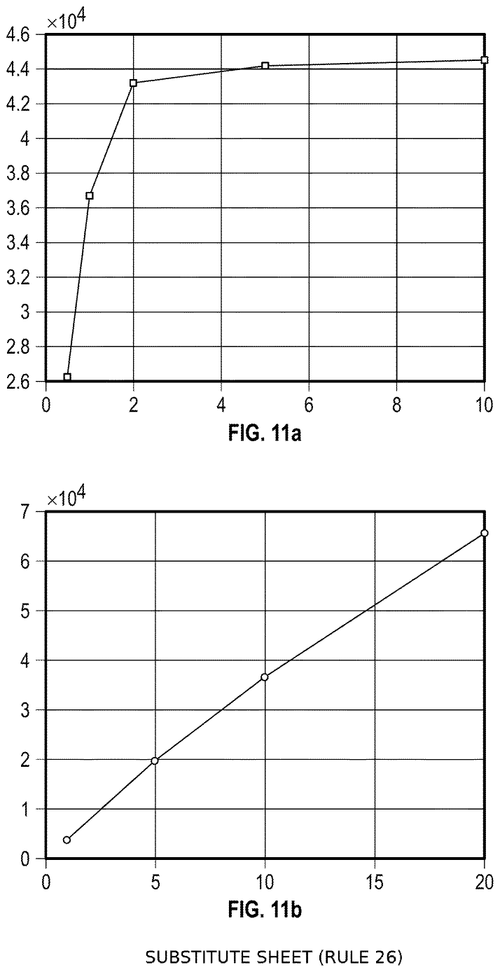

with β being the local heating rate in K/min, R the gas constant, and C an additional constant. By experimental measurement of crystallization temperatures at different heating rates using differential scanning calorimetry (DSC), Eₐ for primary (and secondary) crystallization (corresponding to x1 and x2, respectively) can be determined through fitting. However, most DSC scans can only achieve heating rates that are orders of magnitude below those expected in laser annealing, with the few that can achieve this being prohibitively expensive. A second assumption is made, that the relation between crystallization temperature and heating rate is unchanged at high β, i.e. the Kissinger equation still holds for arbitrarily large β. Using data gathered for a representative Co-rich alloy a heating rate of 10⁴ K/min would result in a Tₓ₁ of 527.7° C. and Tₓ₂ of 732.1° C. These are significantly higher than the temperatures observed at lower heating rates, e.g. 426.3° C. and 628.6° C. respectively for β=20 K/min, but not unreasonably so. The effects of varying relative velocity, and deposited beam power are shown in FIG. 11. It is seen that the maximum heating rate, correlated to the maximum crystallization temperatures required, is a strong function of travel velocity, while it increases linearly with deposited power as expected.

The effect of a nonuniform crystallization temperature may actually be beneficial in annealing treatments where a more spatially uniform microstructure is desired; regions with the highest heating rates also tend to have the highest temperatures and thus have the greatest threshold for crystallization, while lower heating rate regions have lower temperatures but also a lower threshold for crystallization.

### CITED REFERENCES

Inclusion of a citation should not be construed as an admission that the citation constitutes prior art to the instant application.
(1) M. E. McHenry and D. E. Laughlin, in Phys. Metall. Fifth Ed., edited by D. E. Laughlin and K. Hono (Elsevier, Oxford, 2014), pp. 1881-2008.
(2) A. Talaat, D. W. Greve, M. V. Suraj, and P. R. Ohodnicki, J. Alloys Compd. 854, 156480 (2021).
(3) A. Talaat, M. V. Suraj, K. Byerly, A. Wang, Y. Wang, J. K. Lee, and P. R. Ohodnicki, J. Alloys Compd. 870, 159500 (2021).
(4) G. Herzer, Acta Mater. 61, 718 (2013).
(5) Y. Yoshizawa, S. Oguma, and K. Yamauchi, J. Appl. Phys. 64, 6044 (1988).
(6) K. Suzuki, R. Parsons, B. Zang, K. Onodera, H. Kishimoto, T. Shoji, and A. Kato, AIP Adv. 9, 035311 (2019).
(7) D. Azuma, N. Ito, and M. Ohta, J. Magn. Magn. Mater. 501, 166373 (2020).
(8) Y. Liu, M. Zheng, D. J. Sellmyer, and J. Mazumder, in Handb. Adv. Magn. Mater., edited by Y. Liu, D. J. Sellmyer, and D. Shindo (Springer US, Boston, MA, 2006), pp. 1045-1063.
(9) L. Lanotte and V. Iannotti, J. Appl. Phys. 78, 3531 (1995).
(10) S. Katakam, J. Y. Hwang, H. Vora, S. P. Harimkar, R. Banerjee, and N. B. Dahotre, Scr. Mater. 66, 538 (2012).
(11) A. Leary, V. Keylin, A. Devaraj, V. DeGeorge, P. Ohodnicki, and M. E. McHenry, J. Mater. Res. 31, 3089 (2016).
(12) K. Byerly, P. R. Ohodnicki, S. R. Moon, A. M. Leary, V. Keylin, M. E. McHenry, S. Simizu, R. Beddingfield, Y. Yu, G. Feichter, R. Noebe, R. Bowman, and S. Bhattacharya, JOM 70, 879 (2018).
(13) M. A. McGuire and D. S. Parker, J. Appl. Phys. 118, 163903 (2015).
(14) B. Jayakumar and J. C. Hanan, in Residual Stress Thermomechanics Infrared Imaging Hybrid Tech. Inverse Probl. Vol. 8, edited by M. Rossi, M. Sasso, N. Connesson, R. Singh, A. DeWald, D. Backman, and P. Gloeckner (Springer International Publishing, Cham, 2014), pp. 87-92.
(15) H. S. Chen, H. J. Leamy, and C. E. Miller, Annu. Rev. Mater. Sci. 10^{, 363} (1980).
(16) S. P. Harimkar, S. R. Paital, G. Wang, P. K. Liaw, and N. B. Dahotre, Adv. Eng. Mater. 13, 955 (2011).
(17) K. Tan, IEEE Trans. Magn. 22, 188 (1986).
(18) E. A. Theisen, M. J. Davis, S. J. Weinstein, and P. H. Steen, Chem. Eng. Sci. 65, 3249 (2010).
(19) W. J. Parker, R. J. Jenkins, C. P. Butler, and G. L. Abbott, J. Appl. Phys. 32, 1679 (1961).
(20) M. A. Willard and M. Daniil, in Handb. Magn. Mater., edited by K. H. J. Buschow (Elsevier, 2013), pp. 173-342.
(21) P. R. Ohodnicki, D. E. Laughlin, M. E. McHenry, and M. Widom, Acta Mater. 58, 4804 (2010).
(22) U. Köster and U. Herold, in Glas. Met. Ion. Struct. Electron. Transp. Cryst., edited by H.-J. Güntherodt and H. Beck (Springer Berlin Heidelberg, Berlin, Heidelberg, 1981), pp. 225-259.
(23) T. Kulik, J. Non-Cryst. Solids 287, 145 (2001).
(24) U. Köster and J. Meinhardt, Mater. Sci. Eng. A 178, 271 (1994).
(25) M. E. McHenry, F. Johnson, H. Okumura, T. Ohkubo, V. R. V. Ramanan, and D. E. Laughlin, Scr. Mater. 48, 881 (2003).
(26) K. Suzuki, R. Parsons, B. Zang, K. Onodera, H. Kishimoto, T. Shoji, and A. Kato, J. Alloys Compd. 735, 613 (2018).
(27) F. Alves, P. Houée, M. Lécrivain, and F. Mazaleyrat, J. Appl. Phys. 81, 4322 (1997).
(28) R. C. Hall, J. Appl. Phys. 30, 816 (1959).
(29) D. A. Porter, K. E. Easterling, Phase Transformations in Metals and Alloys, Chapman & Hall, 1992.
(30) E. Dargent, A. Denis, C. Galland, J. Grenet, J. Therm. Anal. 1996, 46, 377.

All references, patents or applications, U.S. or foreign, cited in the application are hereby incorporated by reference as if written herein in their entireties. Where any inconsistencies arise, material literally disclosed herein controls.

From the foregoing description, one skilled in the art can easily ascertain the essential characteristics of this invention, and without departing from the spirit and scope thereof, can make various changes and modifications of the invention to adapt it to various usages and conditions.

1. A method for creating an engineered domain structure of an initially amorphous ribbon, the method comprising:
obtaining an amorphous ribbon, comprising:
one or more transition metals; and
one or more elements chosen from B, Al, Ga, C, Si, and Ge;
exposing the amorphous ribbon to laser irradiation.

2. The method as recited in claim 1, wherein the method results in the formation of a nanocrystalline phase.

3. The method as recited in claim 1, further comprising the step of cooling the irradiated material.

4.-7. (canceled)

8. The method as recited in claim 1-7, wherein the amorphous material comprises Fe, Si, Nb, Cu, and B.

9. The method as recited in claim 4, wherein:
the amorphous ribbon has the empirical formula Feₓ₂Siₓ₆Nbₓ₇Bₓ₈Cu;
x2 is between 70 and 80;
x6 is between 15 and 16;
x7 is between 2.5 and 3.5; and
x8 is between 6 and 8.

10. The method as recited in claim 5, wherein the amorphous material has the empirical formula Fe₇₃₋₇₄Si_{15.4-15.6}Nb_{2.9-3.1}B_{6.8-7.2}Cu₁.

11.-13. (canceled)

14. The method as recited in claim 9 6, wherein the amorphous material has the empirical formula Fe_{73.5}Si_{15.5}Nb₃B₇Cu₁.

15. A method for optimizing a property of a material comprising a nanocrystalline phase within an amorphous matrix, the method comprising:
obtaining a material comprising:
an amorphous matrix; and
a nanocrystalline phase within the amorphous matrix;
irradiating a portion of the material to form one or more irradiated spots, comprising
exposing the material to laser irradiation;
altering one or more domain structures inside the one or more irradiated spots; and
optimizing a property of the material, the property selected from the group consisting of magnetism, phase identity of the nanocrystalline phase, volume fraction of the nanocrystalline phase, and grain size of the nanocrystalline phase.

16.-18. (canceled)

19. The method as recited in claim 8, wherein the method produces in the one or more domains a positive or a negative or a vanishing magnetostriction coefficient.

20.-31. (canceled)

32. The method as recited in claim 8, wherein the amorphous matrix comprises:
one or more transition metals; and
one or more elements chosen from B, Al, Ga, C, Si, and Ge.

33.-35. (canceled)

36. The method as recited in claim 8, wherein the amorphous matrix comprises Fe, Si, Nb, B, and Cu.

37. The method as recited in claim 11, wherein:
the amorphous matrix has the empirical formula Feₓ₂Siₓ₆Nbₓ₇Bₓ₈Cu;
x2 is between 70 and 80;
x6 is between 15 and 16;
x7 is between 2.5 and 3.5; and
x8 is between 6 and 8.

38. The method as recited in claim 12, wherein the amorphous matrix has the empirical formula Fe₇₃₋₇₄Si_{15.4-15.6}Nb_{2.9-3.1}B_{6.8-7.2}Cu₁.

39.-41. (canceled)

42. The method as recited in claim 13, wherein the amorphous matrix has the empirical formula Fe_{73.5}Si_{15.5}Nb₃B₇Cu₁.

43. A method for converting an initially fully- or partially-crystalline region in a surface layer of a material to an amorphous domain, the method comprising:
obtaining a material comprising:
a surface layer; and
an initial fully- or partially-crystalline region in the surface layer; and
irradiating a portion of the material to form an amorphous domain, comprising exposing the material to laser irradiation.

44.-45. (canceled)

46. The method as recited in claim 15, wherein the material comprises:
one or more transition metals; and
one or more elements chosen from B, Al, Ga, C, Si, and Ge.

47.-49. (canceled)

50. The method as recited in claim 15, wherein the material comprises Fe, Si, Nb, Cu, and B.

51. The method as recited in claim 17, wherein:
the material has the empirical formula Feₓ₂Siₓ₆Nbₓ₇Bₓ₈Cu;
x2 is between 70 and 80;
x6 is between 15 and 16;
x7 is between 2.5 and 3.5; and
x8 is between 6 and 8.

52. The method as recited in claim 18, wherein the amorphous matrix has the empirical formula Fe₇₃₋₇₄Si_{15.4-15.6}Nb_{2.9-3.1}B_{6.8-7.2}Cu₁.

53.-55. (canceled)

56. The method as recited in claim 19, wherein the material has the empirical formula Fe_{73.5}Si_{15.5}Nb₃B₇Cu₁.

57.-98. (canceled)
